(19) United States
(12) Patent Application Publication
(10) Pub. No.: US 2009/0083052 A1
(43) Pub. Date: Mar. 26, 2009

(54) Virtual Business Object Business Processes in a Virtual Environment

(76) Inventors: Brian R. Bokor, Raleigh, NC (US); Andrew B. Smith, Morrisville, NC (US); William B. Nicol, II, Durham, NC (US); Daniel E. House, Raleigh, NC (US)

Correspondence Address: MOORE & VAN ALLEN, PLLC For IBM, P.O. Box 13706, Research Triangle Park, NC, 27709, US

(21) Appl. No.: 11/861,817

(22) Filed: Sep. 26, 2007

(51) Int. Cl. G06Q 30/00

(52) U.S. Cl. 705/1

(57) ABSTRACT

A method for virtual business object processes in a virtual environment that includes presenting at least one process for selection by an avatar in a virtual environment, the at least one process being encapsulated with a virtual business object (VBO) associated with a completed business transaction in the virtual environment, selecting a process from the at least one process, and executing the selected process. The processes encapsulated in the virtual business object may be interactively updated by a remote process.

### BACKGROUND OF THE INVENTION

The present invention is related to processes in a virtual environment, and more specifically to virtual business object business processes in a virtual environment.

An avatar is a virtual world user/character that represents and is controlled by a person at a workstation or server. Virtual world transactions between a buyer and a seller or business, represented as an avatar buyer and an avatar seller or an online business (or a business represented by an avatar), respectively, are becoming increasingly more popular. However, currently problems exist with virtual world transactions and policies around the products involved in the transactions. Moreover, virtual purchases currently have accountability problems and don't really mimic the ideals around real world or even online purchases that currently take place. In the real world, after a product is purchased, policies associated with the purchase or product may become available such as warranties, guarantees, exchange policies etc. However, currently in virtual world transactions, processes to provide policies associated with a transaction and associated data do not exist.

Moreover, currently there are no mechanisms to provide online or dynamic content about a business transaction, or to provide this content in a unified form. Many items currently are paper-based or a manual process (e.g., paper warranties, paper manuals, paper receipts, etc.) requiring a person have to print out papers related to the transaction. Also, most components of a transaction are disjointed and separate items that are difficult to manage as one cohesive unit In addition, information related to online transactions are usually kept within the domains of the online site where purchased, and provide no mechanism for updating the content or allowing a buyer to take it with him.

### BRIEF SUMMARY OF THE INVENTION

According to one aspect of the present invention, a method for virtual business object processes in a virtual environment that includes presenting at least one process for selection by an avatar in a virtual environment, the at least one process being encapsulated with a virtual business object (VBO) associated with a completed business transaction in the virtual environment, selecting a process from the at least one process, and executing the selected process.

According to another aspect of the present invention, a system for virtual business object processes in a virtual environment includes a server, one or more workstations, and a network interconnecting the server and the one or more workstations, wherein the server presents at least one process for selection by an avatar in the virtual environment, the at least one process being encapsulated with a virtual business object (VBO) associated with a completed business transaction in the virtual environment, the avatar selecting a process from the at least one process, and the VBO executing the selected process.

According to a further aspect of the present invention, a computer program product comprising a computer useable medium having computer useable program code embodied therewith, the computer useable program code comprising computer useable program code configured to present at least one process for selection by an avatar in a virtual environment, the at least one process being encapsulated with a virtual business object (VBO) associated with a completed business transaction in the virtual environment, computer useable program code configured to select a process from the at least one process, and computer useable program code configured to execute the selected process.

### BRIEF DESCRIPTION OF THE DRAWINGS

The present invention is further described in the detailed description which follows in reference to the noted plurality of drawings by way of non-limiting examples of embodiments of the present invention in which like reference numerals represent similar parts throughout the several views of the drawings and wherein:

FIG. 1 is a diagram of a system for virtual business object processes in a virtual environment according to an example embodiment of the present invention;

FIG. 2 is a diagram of a virtual environment for a virtual business object business process according to an example embodiment of the present invention;

FIG. 3 is a diagram of actions and processes associated with a virtual business object according to an example embodiment of the present invention;

FIG. 4 is a flowchart of creation/execution of a business process in a virtual environment according to an example embodiment of the present invention;

FIG. 5 is a flowchart of a guarantee process in a virtual environment according to an example embodiment of the present invention;

FIG. 6 is a flowchart of a warranty process according to an example embodiment of the present invention; and

FIG. 7 is a flowchart of an exchange process according to an example embodiment of the present invention.

### DETAILED DESCRIPTION OF THE INVENTION

As will be appreciated by one of skill in the art, the present invention may be embodied as a method, system, computer program product, or a combination of the foregoing. Accordingly, the present invention may take the form of an entirely hardware embodiment, an entirely software embodiment (including firmware, resident software, micro-code, etc.) or an embodiment combining software and hardware aspects that may generally be referred to herein as a “system.” Furthermore, the present invention may take the form of a computer program product on a computer-usable storage medium having computer-usable program code embodied in the medium.

Any suitable computer usable or computer readable medium may be utilized. The computer usable or computer readable medium may be, for example but not limited to, an electronic, magnetic, optical, electromagnetic, infrared, or semiconductor system, apparatus, device, or propagation medium. More specific examples (a non-exhaustive list) of the computer readable medium would include the following: an electrical connection having one or more wires; a tangible medium such as a portable computer diskette, a hard disk, a random access memory (RAM), a read-only memory (ROM), an erasable programmable read-only memory (EPROM or Flash memory), a compact disc read-only memory (CD-ROM), or other tangible optical or magnetic storage device; or transmission media such as those supporting the Internet or an intranet. Note that the computer usable or computer readable medium could even be paper or another suitable medium upon which the program is printed, as the program can be electronically captured, via, for instance, optical scanning of the paper or other medium, then compiled, interpreted, or otherwise processed in a suitable manner, if necessary, and then stored in a computer memory.

In the context of this document, a computer usable or computer readable medium may be any medium that can contain, store, communicate, propagate, or transport the program for use by or in connection with the instruction execution system, platform, apparatus, or device. The computer usable medium may include a propagated data signal with the computer-usable program code embodied therewith, either in baseband or as part of a carrier wave. The computer usable program code may be transmitted using any appropriate medium, including but not limited to the Internet, wireline, optical fiber cable, radio frequency (RF) or other means.

Computer program code for carrying out operations of the present invention may be written in an object oriented, scripted or unscripted programming language such as Java, Perl, Smalltalk, C++ or the like. However, the computer program code for carrying out operations of the present invention may also be written in conventional procedural programming languages, such as the “C” programming language or similar programming languages.

The present invention is described below with reference to flowchart illustrations and/or block diagrams of methods, apparatus (systems) and computer program products according to embodiments of the invention. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer-readable memory that can direct a computer or other programmable data processing apparatus to function in a particular manner, such that the instructions stored in the computer readable memory produce an article of manufacture including instruction means which implement the function/act specified in the flowchart and/or block diagram block or blocks.

The computer program instructions may also be loaded onto a computer or other programmable data processing apparatus to cause a series of operations to be performed on the computer or other programmable apparatus to produce a computer implemented process such that the instructions which execute on the computer or other programmable apparatus provide steps for implementing the functions/acts specified in the flowchart and/or block diagram block or blocks. Alternatively, computer program implemented steps or acts may be combined with operator or human implemented steps or acts in order to carry out an embodiment of the invention.

Embodiments according to the present invention apply various types of policies and processes associated with a virtual purchase or transaction that may be tracked from the time and date of purchase. These policies may be encapsulated in a virtual business object associated with the transaction. Therefore, the policies/processes are permanently associated with the virtual business object related to the product or transaction. Further, although a policy or process may subsequently be changed for future purchases, of the same or other products, a buyer may be locked into the policy/process generated at the time of the original purchase for that transaction. This eliminates possible agreement disputes that may come from changes since a product or service provider (who may have changed the policy or process) may apply different policies per product or service being sold.

According to embodiments of the present invention, one or more policies may be attached to a virtual business object (VBO) that is delivered upon purchase of a product or service and completion of this transaction. A user controlling an avatar in the virtual world may display and view on a screen the various processes or policies associated with a virtual business object when viewing the product's properties. For example, if a warranty policy has be encapsulated in the virtual business object associated with the purchase of a product, then after the buyer has determined that he is satisfied with the product after transaction completion, a time period may begin to countdown (e.g., 30 days) upon which when expired, the warranty policy/process may be inactivated in the virtual business object. During the active period of the policy/process, the policy/process may run in a remote server location (possibly owned by the product supplier, manufacturer, or vendor) and may be updateable. Thus policies/processes encapsulated in the virtual business object may be interactively updated by a remote process from a product supplier, vendor, distributor, store, etc where the product supplier may submit updates to the virtual business object for the associated policies/processes needing updating. The updates may be based on current changes, revisions, etc. The updates may be initiated by a user (e.g., a buyer, a product supplier, a vendor, a distributor, a store, etc) or the VBO and/or the policies/processes may automatically check periodically for any updates and retrieve the updates. Although a virtual business object may have several different encapsulated policies/processes that are associated with a product or business transaction, to help illustrate embodiments of the present invention, a warranty process, a guarantee process, and an exchange process will be discussed.

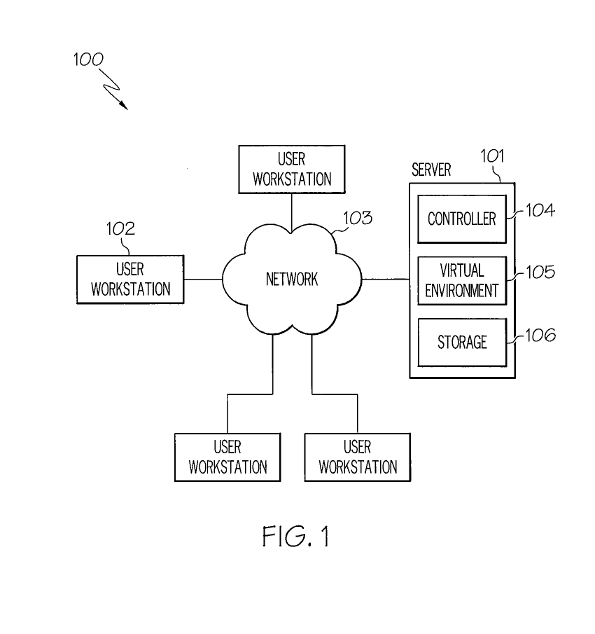

FIG. 1 shows a diagram of a system for virtual business object processes in a virtual environment according to an example embodiment of the present invention. The system 100 may include a server 101 and one or more workstations 102 where the server 101 and the one or more workstations 102 may be interconnected to a network 103. Although one server 101 is shown, there may be multiple servers connected to the network 103 and accessible by the one or more workstations 102. The server 101 may host the virtual environment 105 and also contain a controller 104 and storage 106. Therefore, a buyer at a workstation 102 may access the virtual environment 105 hosted on the server 101 and control an avatar in the virtual environment 105 to buy products or make other purchases or business transactions with a person, a store, vendor, manufacturer, supplier, etc., which may also access the virtual environment and provide the products or services for sale in the virtual environment. The supplier of the product or services may also access the virtual world or environment 105 hosted on the server 101 via one or more workstations 102. Further, the processes/policies may be supplied by a supplier of the product, a vendor, a retailer, or a manufacturer upon completion of the transaction and generation of the virtual business object.

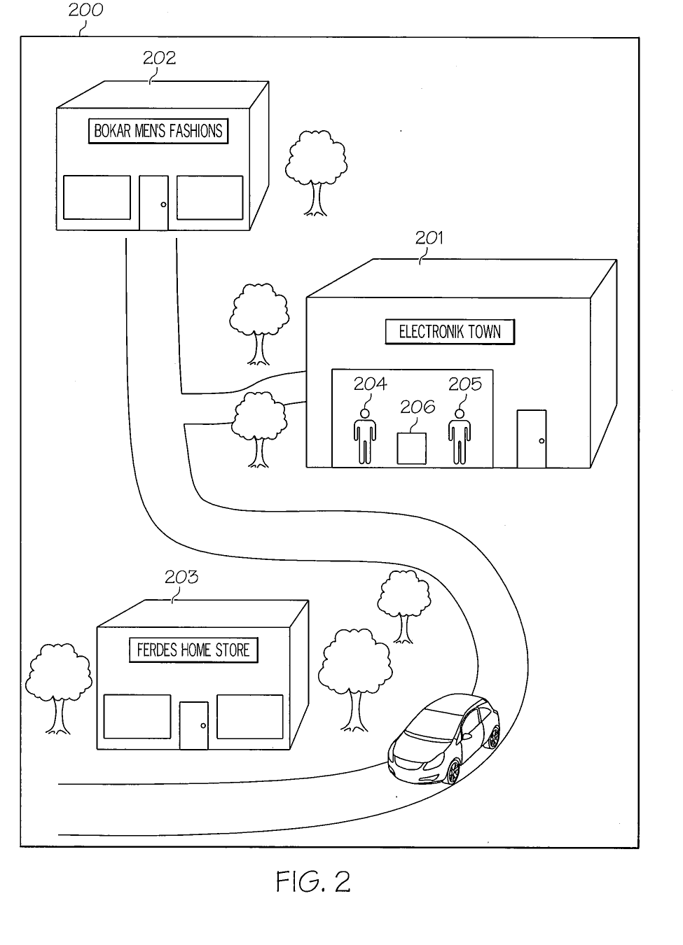

FIG. 2 shows a diagram of a virtual environment for a virtual business object business process according to an example embodiment of the present invention. In the virtual environment/world 200 there may exist an environment containing buildings, stores, trees, cars, people (represented by avatars) and any other items that currently exist in the real world. For example, a virtual world may contain virtual businesses or stores 201, 202, 203 that allow an avatar buyer to purchase products or services from an avatar seller. In this example embodiment, an avatar buyer 204 in a virtual business “Electronik Town” 201 is purchasing a product 206 from an avatar seller 205 at the virtual business “Electronik Town” 201. Upon completion of this transaction, a virtual business object may be generated and various policies/processes supplied by the avatar seller 205, or other sources, that may be encapsulated into the virtual business object.

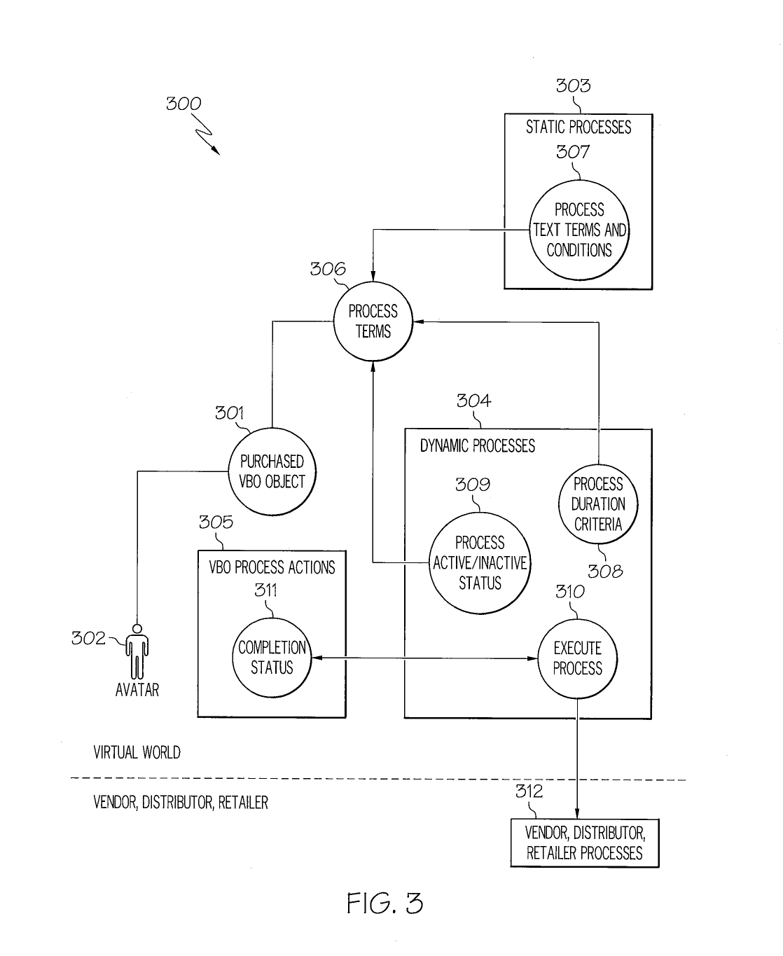

FIG. 3 shows a diagram of actions and processes associated with a virtual business object according to an example embodiment of the present invention. A virtual business object 301 may be accessed by an avatar 302 in a virtual world where the virtual business object 301 may have different types of policies/processes associated with it such as, for example, static processes 301, dynamic processes 304, virtual business object process actions 305, etc. Static processes may include text items or other items that are typically do not change such as process text terms and conditions 307, for example, a virtual receipt, a virtual parts list associated with the product related to the virtual business object, etc.

Dynamic processes 304 may include, for example, process duration criteria 308, process active/inactive status 309, an execution process 3 10, etc. For example, if the process is a warranty process, the process duration criteria 308 may be, for example, 30 days whereby the process in the virtual business object may count down the 30 day period upon activation of the process and fed this information into the process terms 306 associated with the virtual business object. Further, should the warranty process expire, the process active/inactive status 309 may provide this information to process terms 306 associated with the warranty process of the virtual business object 301. In addition, should a user/avatar 302 access the virtual business object 301 to execute terms of their warranty, the execute process 310 may be performed. In this regard, the user/avatar 302 may interactively communicate with vendor, distributor or retailer processes 312 once the execute process 310 is initiated. Upon completion, the execute process 310 may supply completion status to a completion status process 311 in the virtual business object process actions 305.

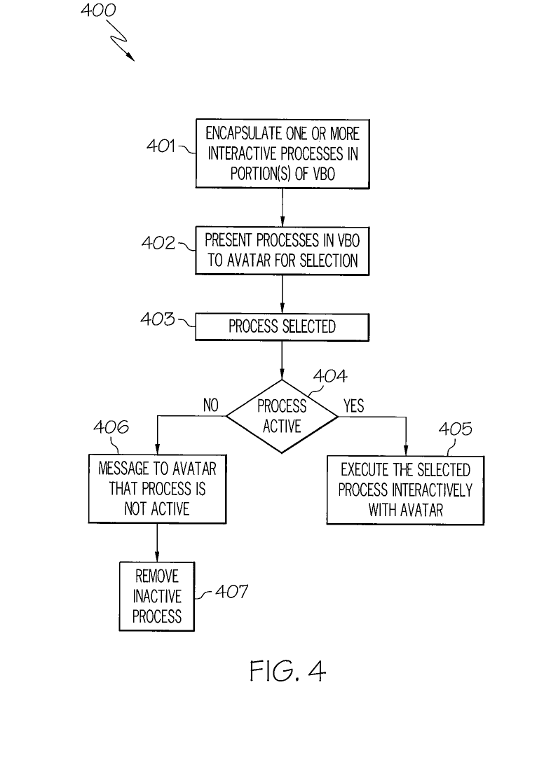

FIG. 4 shows a flowchart of creation/execution of a business process in a virtual environment according to an example embodiment of the present invention. In the process 400, in block 401, one or more interactive processes may be encapsulated into portions of a virtual business object. In block 402, processes in the virtual business object may be presented to an avatar for selection. In block 403, the avatar may select one of the processes. In block 404, it may be determined whether the process is active and if so, in block 405, the selected process may be executed interactively with the avatar. If it is determined in block 404 that the process is not active, in block 406, a message may be generated to the avatar that the process is not active and in block 407, the inactive process may be removed from the virtual business object automatically or upon initiation by the avatar buyer or seller, or could be made into viewable/non-editable information rather than a processing interaction (i.e., action buttons, to interact with the process, no longer available or disabled).

According to embodiments of the present invention, generic encapsulated business processes may be included in the VBO. Coupled generic business processes may be used to drive any function from the VBO, including feedback, etc, to the transaction originator. Further, there may be various levels of feedback. For example, feedback to a vender on purchase experience, feedback to a distributor surrounding delivery concerns, feedback to a manufacturer for defect issues, etc. This may provide customer feedback to the distributor, or seller, which they may then potentially use for marketing, product or process improvement, or other purposes.

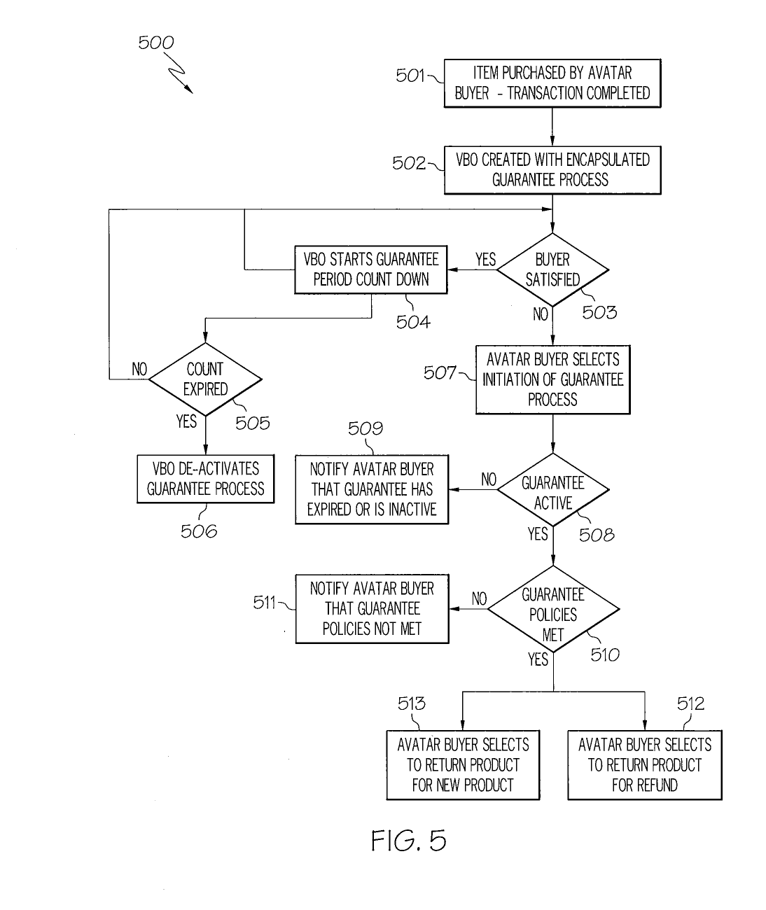

FIG. 5 shows a flowchart of a guarantee process in a virtual environment according to an example embodiment of the present invention. In the process 500, in block 501, an item may be purchased by an avatar buyer and the transaction completed. In block 502, a virtual business object may be created with an encapsulated guarantee process. In block 503, it may be determined if the buyer is satisfied with the purchased item and if so, in block 504, the virtual business object may start a guarantee period countdown and, in block 505, monitor whether the count has expired and if not, the process may return to block 503 to determine if the buyer is still satisfied. If in block 505, the count has expired, the virtual business object may deactivate the guarantee process automatically or upon initiation by the avatar buyer or seller.

If the buyer is not satisfied, in block 507, the avatar buyer may select initiation of the guarantee process. In block 508, it may be determined if the guarantee is active and if not, in block 509, the avatar buyer may be notified that the guarantee has expired or is inactive. If the guarantee is active, in block 510, it may be determined whether the guarantee policies have been met, and if not, in block 511 the avatar buyer may be notified that the guarantee policies have not been met. In this regard, the guarantee may be active as long as the expiration period has not expired. Further, although the guarantee may be active, the item may have been dropped or damaged or some other occurrence may have happened which does not meet criteria allowing exercising the guarantee policy. If the guarantee policies have been met, in block 512, an avatar buyer may select to return the product for a refund or in block 513 may select to return the product for a new product.

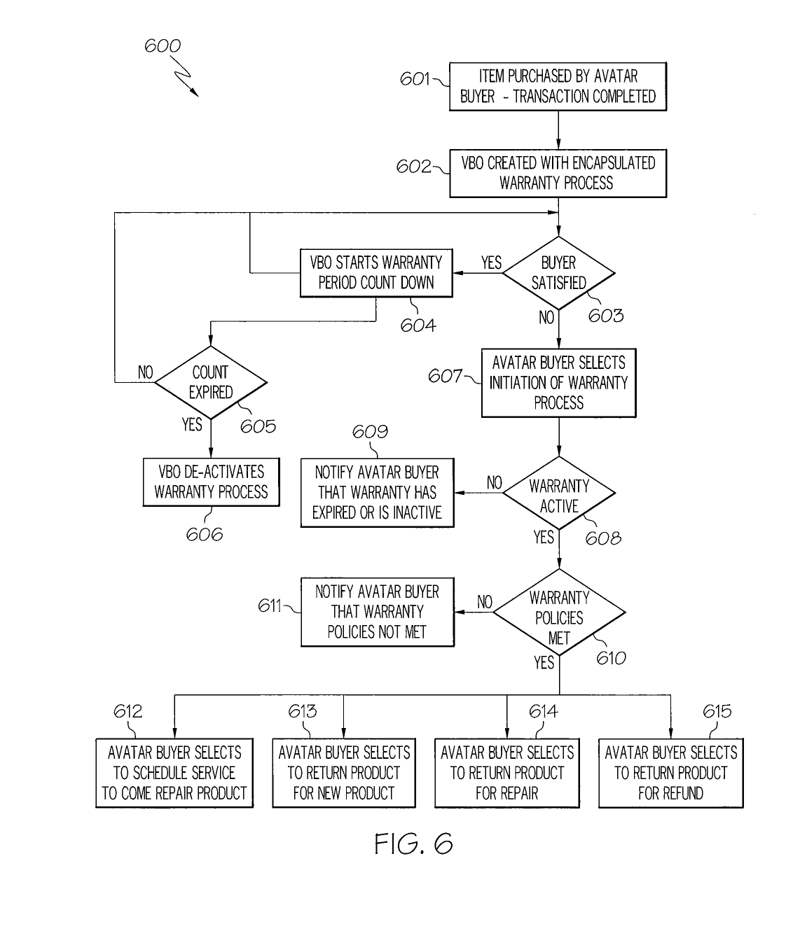

FIG. 6 shows a flowchart of a warranty process according to an example embodiment of the present invention. In the process 600, in block 601, an item may be purchased by an avatar buyer and the transaction completed. In block 602, a virtual business object may be created upon transaction completion with encapsulated warranty process. In block 603, it may be determined whether the buyer is satisfied and if so, in block 604, the virtual business object may start a warranty period countdown, and then in block 605 monitor the count to determine if it has expired. If the countdown has not expired, the process may return to determination of whether the buyer is satisfied, or if the count has expired, in block 606, the virtual business object may deactivate the warranty process automatically or upon initiation by the avatar buyer or vendor.

If the avatar buyer is not satisfied, in block 607, the avatar buyer may select initiation of the warranty process. In block 608, it may be determined if the warranty is active (e.g., warranty period still exists) and if not, in block 609 the avatar buyer may be notified that the warranty has expired or is inactive. If the warranty is active, in block 610, it may be determined whether policies associated with the warranty have been met and if not, in block 611, the avatar buyer may be notified that the warranty policies have not been met. If the warranty policies have been met, in block 612 the avatar buyer may select to schedule service to come and repair the product, or in block 613 may select to return the product for a new product, or in block 614 may select to return the product for repair, or in block 615 may select to return the product for a refund.

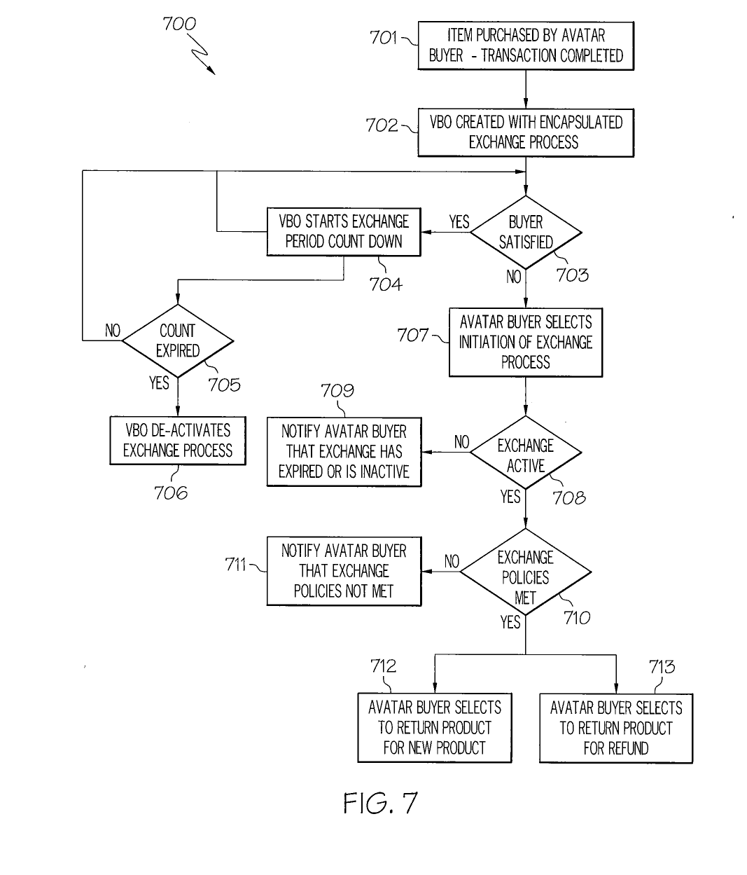

FIG. 7 shows a flowchart of an exchange process according to an example embodiment of the present invention. In the process 700, in block 701, an item may be purchased by an avatar buyer and the transaction completed. In block 702, a virtual business object with an encapsulated exchange process may be created upon transaction completion. In block 703 it may be determined if the buyer is satisfied and if so, in block 704, the virtual business object may start an exchange period countdown, and then monitor in block 705 whether the count has expired. If the count has not expired, the process may return to determination of whether the buyer is satisfied. If the count has expired, in block 706 the virtual business object may deactivate the exchange process automatically or upon initiation from the avatar buyer.

If the buyer is not satisfied, in block 707, the avatar buyer may select initiation of the exchange process. In block 708 it may be determined if the exchange process is active and if not, in block 709, the avatar buyer may be notified that the exchange process has expired or is inactive. If the exchange process is active, in block 710, it may be determined whether the exchange policies have been met and if not, in block 711, the avatar buyer may be notified that the exchange policies have not been met. If the exchange policies have been met, in block 712 the avatar buyer may select to return the product for a new product or in block 713 the avatar buyer may select to return the product for a refund.

The flowcharts and block diagrams in the Figures illustrate the architecture, functionality, and operation of possible implementations of systems, methods and computer program products according to various embodiments of the present invention. In this regard, each block in the flowchart or block diagrams may represent a module, segment, or portion of code, which comprises one or more executable instructions for implementing the specified logical function(s). It should also be noted that, in some alternative implementations, the functions noted in the blocks may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems which perform the specified functions or acts, or combinations of special purpose hardware and computer instructions.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

Although specific embodiments have been illustrated and described herein, those of ordinary skill in the art appreciate that any arrangement which is calculated to achieve the same purpose may be substituted for the specific embodiments shown and that the invention has other applications in other environments. This application is intended to cover any adaptations or variations of the present invention. The following claims are in no way intended to limit the scope of the invention to the specific embodiments described herein.

What is claimed is:

1. A method for virtual business object processes in a virtual environment comprising:
presenting at least one process for selection by an avatar in a virtual environment, the at least one process being encapsulated with a virtual business object (VBO) associated with a completed business transaction in the virtual environment;
selecting a process from the at least one process; and
executing the selected process.

2. The method according to claim 1, further comprising executing the selected process interactively with the avatar.

3. The method according to claim 1, further comprising executing the selected process interactively with a seller involved in the business transaction.

4. The method according to claim 1, further comprising executing the selected process interactively with an entity not involved in the business transaction.

5. The method according to claim 1, further comprising determining whether the process is valid before executing the selected process.

6. The method according to claim 1, further comprising a warranty process being encapsulated with a virtual warranty portion of the virtual business object.

7. The method according to claim 6, further comprising selecting the warranty process by the avatar and executing the warranty process by determining if an item related to the business transaction is under warranty and disabling the virtual warranty portion if the item is not under warranty.

8. The method according to claim 7, the executing the warranty process further comprising determining if an item related to the business transaction is under warranty by the warranty process and providing options for selection by the avatar if the item is under warranty.

9. The method according to claim 8, the executing the warranty process further comprising providing options for selection by the avatar comprising at least one of receiving compensation for the item, receiving a new item, and repairing the item.

10. The method according to claim 1, further comprising a guarantee process being encapsulated with a virtual guarantee portion of the virtual business object.

11. The method according to claim 10, further comprising selecting the guarantee process by the avatar and executing the guarantee process by determining if an item related to the business transaction has a guarantee and disabling the virtual guarantee portion if the item does not have a guarantee.

12. The method according to claim 11, the executing the guarantee process further comprising determining if an item related to the business transaction is has a guarantee by the guarantee process and providing options for selection by the avatar if the item has a guarantee.

13. The method according to claim 12, the executing the guarantee process further comprising providing options for selection by the avatar comprising at least one of returning the item to receive compensation for the item and returning the item for a new item.

14. The method according to claim 1, further comprising updating the at least one process encapsulated with the VBO based on recent changes to the at least one process.
